(19) United States
(12) Patent Application Publication
(10) Pub. No.: US 2005/0071768 A1
(43) Pub. Date: Mar. 31, 2005

(54) Method, apparatus, system, and program for providing a virtual office, and a medium storing the program

(76) Inventors: Tadashi Araki, Kanagawa-ken (JP); Kaoru Maeda, Chiba-ken (JP)

Correspondence Address: DICKSTEIN SHAPIRO MORIN & OSHINSKY LLP, 2101 L Street, NW, Washington, DC, 20037, US

(21) Appl. No.: 10/921,922

(22) Filed: Aug. 20, 2004

(30) Foreign Application Priority Data
Aug. 22, 2003 (JP) 2003-299235

(51) Int. Cl. G06F 3/00; G06F 9/00

(52) U.S. Cl. 715/757; 715/760

(57) ABSTRACT

A method, apparatus, system, computer program, and related computer medium are provided to perform an operation of providing a virtual office to users logged on a network. The network includes a server terminal and client terminals. The server terminal performs operations of allowing the client terminals to log on the network based on login information, storing data received from the client terminals, creating the virtual office using the data, and providing the virtual office to the client terminals in a format readable to the client terminals. Further, the server terminal performs operations of starting synchronized communication among the users according to various rules previously set by the users, and displaying information that the communication has started. Through these operations, the users can communicate with one another in a real time environment, as if they were in the physically same location.

### BACKGROUND OF THE INVENTION

With recent developments in broadband networks, various types of office work arrangements have been introduced, such as satellite offices and home offices, which are located far from their headquarter offices. In facilitating communications among the employees working in such offices, a concept of virtual office is playing an important role.

The virtual office concept may be defined as a work environment, in which employees can work cooperatively from different locations using a computer network.

One advantage of the virtual office concept is that the employees can easily interact and communicate with one another, usually in a real time environment, as if they were in the same physical locations. This would be achieved through various types of synchronized communication, including videoconferencing, teleconferencing, and chatting, for example.

To simulate face-to-face communications, the synchronized communication desirably would have the following characteristics:

A user can easily start communication with another, or can easily participate in communication that the other is currently involved in;
The user can accept or deny the request for communication received from the other;
The user can have access to information about communications currently held in the virtual office;
The user can conceal the above information from the other for security reasons; and
The user can show to the other, if he or she is available for communications.

### BRIEF SUMMARY OF THE INVENTION

The present invention provides a method, apparatus, system, and related computer program product or medium, for providing a virtual office, in which users working at different locations can communicate with one another in a real time environment over a network.

In one example, the virtual office may be generated on a network, in which a server terminal and a plurality of client terminals are connected.

The server terminal generally includes a processor and a storage device. The storage device previously stores a plurality of instructions which, when executed by the processor, cause the processor to operate as a server.

Such operation may include querying the client terminals for login information, authenticating the client terminals based on the login information, requesting the client terminals to send various data, storing the data in the storage device, creating a virtual office using the data, and providing the virtual office to the client terminals in a format readable to the client terminals.

The server terminal generally includes a processor, a display, an input device, and a storage device. The storage device previously stores a plurality of instructions which, when executed by the processor, cause the processor to operate as a client.

Such operation includes sending the login information to the server terminal, sending various data to the server terminal, requesting the server terminal to provide the virtual office, and displaying the virtual office on the display, using a browser.

In one example, the data may include images of the users logged on the network, identification information of the users, and various rules previously set by the users.

Examples of such data include user IDs, passwords, ranks, user groups, IP addresses, access rules, display rules, participation rules, and rank rules.

The access rule specifies whether the users are available for synchronized communication. The display rule specifies whether the information that the communication has started can be displayed. The participation rule specifies whether the users can participate in the synchronized communication being currently held. The rank rule specifies authority levels of the users in the virtual office, in relationship with the ranks of the users.

One advantage of generating the virtual office on the network is that the users of the client terminals can communicate with one another in a real time environment.

To perform such synchronized communication, the operation as the server may further include allowing the client terminals to start synchronized communication according to the various rules, and displaying information that the synchronized communication has started.

To perform the above-described communication, the operation as the client may further include setting the various rules regarding the operation in the virtual office, and sending the synchronized communication request to the server terminal.

In this way, the users of the virtual office can freely communicate with one another, in a real time environment, as if they were in the physically same location.

As will be apparent to those skilled in the art and as will be readily obtained from the following descriptions, the present invention may be implemented in various ways, as an apparatus, method, system, computer program or medium.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIGS. 1A and 1B are schematic diagrams illustrating an exemplary structure of a virtual office providing system according to a preferred embodiment of the present invention;

FIG. 2 is a block diagram illustrating exemplary structures of a client terminal and a server terminal, respectively, shown in FIGS. 1A and 1B;

FIG. 3 is an exemplary table stored in the client terminal of FIG. 2;

FIG. 4 is an exemplary operation performed by the client and server terminals of FIG. 2;

FIG. 5 is an exemplary displayed image, representing a virtual office according to another preferred embodiment of the present invention;

FIG. 6 is an exemplary operation of requesting synchronized communication, performed by a client terminal according to another preferred embodiment of the present invention;

FIG. 7 is an exemplary displayed image, representing a virtual office, when a plurality of users is selected;

FIG. 8 is an exemplary displayed image, representing a virtual office, when a user group is selected;

FIG. 9 is an exemplary operation of starting synchronized communication performed by a server terminal, according to another preferred embodiment of the present invention;

FIG. 10 is an exemplary displayed image, representing a virtual office, when a plurality of users is in synchronized communication;

FIG. 11 is another exemplary displayed image, representing the virtual office shown in FIG. 10;

FIG. 12 is an exemplary displayed image, representing a virtual office, when a user group is in synchronized communication;

FIG. 13 is another exemplary displayed image, representing the virtual office shown in FIG. 12;

FIG. 14 is an exemplary operation of setting a rule performed by a client terminal, according to another preferred embodiment of the present invention;

FIG. 15 is an exemplary operation of setting a display rule performed by a client terminal, according to another preferred embodiment of the present invention;

FIG. 16 is an exemplary operation of setting a participation rule performed by a client terminal, according to another preferred embodiment of the present invention;

FIG. 17 is an exemplary operation of setting an access rule performed by a client terminal, according to another preferred embodiment of the present invention;

FIG. 18 is an exemplary table generated by a server terminal according to another preferred embodiment of the present invention;

FIG. 19 is an exemplary displayed image, representing a virtual office, when a meeting is held confidentially, according to another preferred embodiment of the present invention;

FIG. 20 is an exemplary displayed image, representing the virtual office shown in FIG. 19;

FIG. 21 is an exemplary displayed image, representing a virtual office, when a user tries to join in synchronized communication being currently held, according to another preferred embodiment of the present invention;

FIG. 22 is an exemplary displayed image, representing the virtual office shown in FIG. 21;

FIG. 23 is an exemplary displayed image, representing a virtual office, when different availability levels are displayed, according to another preferred embodiment of the present invention;

FIG. 24 is another exemplary displayed image, representing the virtual office shown in FIG. 19; and

FIG. 25 is an exemplary operation of controlling an operation in a virtual office, according to another preferred embodiment of the present invention.

### DETAILED DESCRIPTION OF THE INVENTION

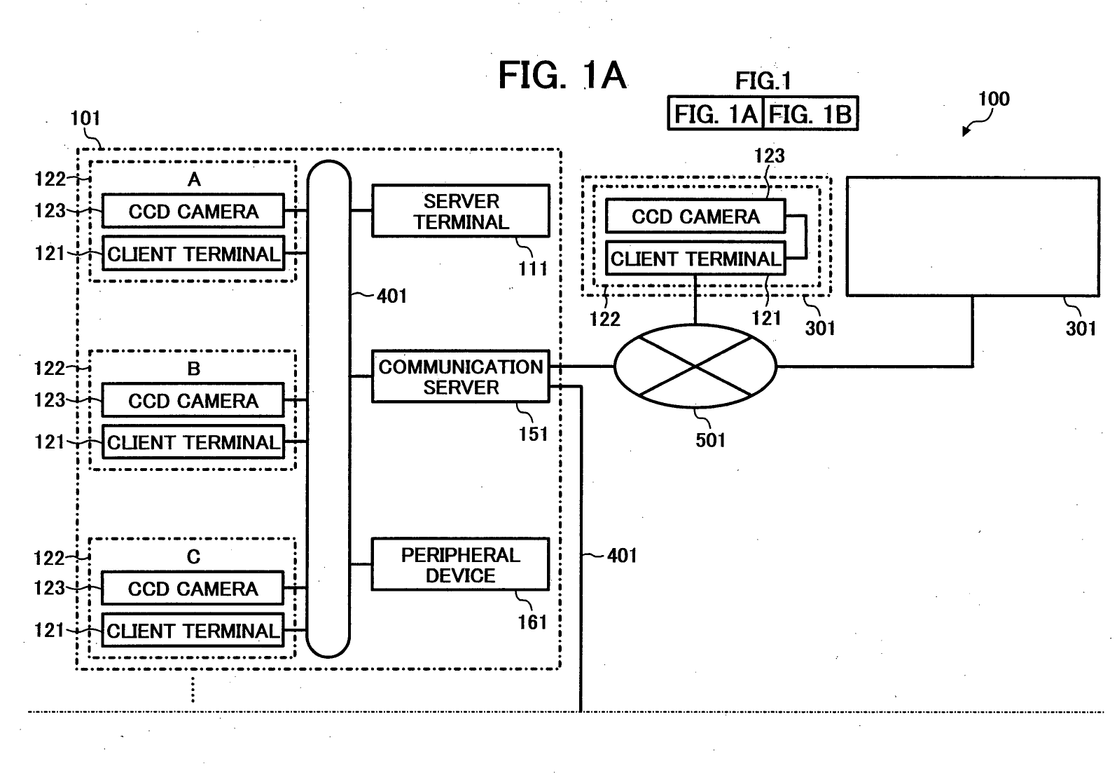

In describing preferred embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner. Referring now to the drawings, wherein like reference numerals designate identical or corresponding parts throughout the several views, particularly to FIGS. 1A and 1B, a description is made for a virtual office providing system 100 according to a preferred embodiment of the present invention.

As shown in FIGS. 1A and 1B, the virtual office providing system 100 mainly includes a main office 101, satellite offices 201, and home offices 301. The main office 101 corresponds to a company's headquarter or corporate office. The satellite office 201 corresponds to a remote small office or a branch office, remotely located from the main office 101, and it is connected to the main office 101 via a network 401. The home office 301 corresponds to a home office, wherein an employee works primarily at home as a telecommuter, and it is connected to the main office 101 via a network 501. Further, the satellite offices 201 are connected to each other via the network 401. The home offices 301 are connected to each other via the network 501.

In this example, the network 401 preferably includes a LAN (local area network) and a WAN (wide area network). However, it may further include a non-wired communications network or a broadcast wave network, as long as it establishes communications between the main office 101 and the satellite office 201. The network 501 preferably includes the Internet, for example.

FIGS. 1A and 1B illustrate two satellite offices 201 and two home offices 301, however, it is more practical to include more than two satellite offices 201 and more than two home offices 301. Alternatively, if the virtual office providing system 100 is small in size, it may include one satellite office 201 and one home office 301.

The main office 101 includes a server terminal 111, a communications server 151, a peripheral device 161, and a plurality of offices 122, which are connected to one another via the network 401. Each of the plurality of offices 122 is provided with a client terminal 121 and a CCD (charge coupled device) camera 123. In this example, the main office 101 includes three offices 122, however, it is more practical to include the offices 122 of larger number.

The server terminal 111 includes a computer or a computer program, which provides various services to the client terminals 121 via the network 401. In this specific example, the server terminal 111 provides a virtual office to the client terminals 121.

The virtual office according to an exemplary embodiment of the present invention may be defined as an office environment, in which employees at different locations can share the same office information or communicate with one another, as if they were in the same physical location. The office information includes, for example, information about whether an employee is present in the office, information whether an employee is busy, information about whether an employee is available for communications, etc. In other words, the office information includes any information that can be easily attained in the traditional office environment, but otherwise is not easily attained without the virtual office environment of the present invention.

The communications server 151 includes a computer or a program, which provides various communications services to the client terminals 121 via the network 401. For example, through the communications server 151, the client terminals 121 can transfer data to or access information stored in the satellite office 201 or the home office 301 via the networks 401 or 501. In addition, the communications server 151 helps the client terminals 121 to share the virtual office over the network 401 or 501.

The peripheral device 161 is any kind of device that works in conjunction with the server terminal 111 and the client terminals 121, including, for example, a multifunctional printer, a printer, a scanner, a facsimile, and a storage device.

The client terminals 121 each include a computer or a computer program, which uses various services provided by the server terminal 111. The client terminal 121 is assigned to an individual employee or user (hereinafter, the user is used interchangeably with the employee) who works in the specific office 122. In this specific example, the client terminals 121 are assigned respectively to users A, B, and C, as shown in FIG. 1A.

The CCD cameras 123 each function as a camera, which obtains an image of the user at the client terminal 121. The CCD camera 123 may be fixed onto or incorporated in a display (not shown) provided on the client terminal 121, or it may be provided anywhere in the office 122 as long as it can take an image of the user. The CCD camera 123 takes an image of the user, as a still or moving image, at a predetermined time during the operation of the virtual office providing system 100.

The satellite office 201 is substantially similar in configuration to the main office 101. Compared to the main office 101, the satellite office 201 usually has the offices 122 of a smaller number. In this specific example, the satellite office 201 includes two offices 122, each provided with the client terminal 121 and the CCD camera 123. As described above in the case of the main office 101, the server terminal 111 and the client terminal 121 together create a server-client system on the network 401. In this case, the client terminals 121 are assigned to a user X, and a user Y, respectively, as shown in FIG. 1B.

The home office 301 includes one office 122, which is provided with the CCD camera 123 and the client terminal 121. Although the number of offices 122 depends on the size of the home office 301, the home office 301 generally includes only one office 122, in which one employee works. Thus, the office 122 is not provided with any server terminal 111 or communications server 151. However, it is technically possible to add the server terminal 111 or the communications server 151, if more than one office 122 are provided. In such a situation, however, the home office 301 functions as the satellite office 201.

The peripheral device 161 is not shown in the home office 301 of FIG. 1A, however, the client terminal 121 may be connected to the peripheral device 161, such as a printer, facsimile, scanner, etc. The client terminal 121 is connected to the communications server 151 of the main office 101 via the network 501. In other words, the employee of the home office 301 can share information and resources (including the peripheral device 161) that the server terminal 111 provides. Specifically, such shared information and resources may be also represented by the virtual office. Further, in such a case, it is more practical to use a conventional encryption technique for network security.

In this exemplary embodiment, the offices 121 are spatially isolated from one another, even if they belong to the same office 101, 201 or 301. For example, the offices 121 in the main office 101 are physically apart from one another but most likely occupy the same building or floor. On the other hand, the offices 121 are spatially isolated from one another at a greater distance, if they belong to different offices. In one example, the main office 101 may be located in Washington, D.C., the satellite office 201 may be located in New York, and the home office 301 may be located in Los Angeles. In another example, the main office 101 may be located in Washington, D.C., the satellite office 201 may be located in Tokyo, and the home office 301 may be located in London.

In the above cases, the individual employee of the office 122 can not easily check the presence of other employees working in the other offices 122, or the individual employee of the office 122 can not easily develop a feeling that they are working together in the same company.

To solve this problem, the virtual office providing system 100 provides the virtual office, in which any employee using the client terminal 121 can easily check the presence of other employees using the client terminals 121 and communicate with them in a real time environment. With this virtual office, the individual employee can easily develop a feeling that they are working together in the same office environment.

The above-described operation of providing the virtual office is mainly carried by the sever terminal 111 and the client terminals 121.

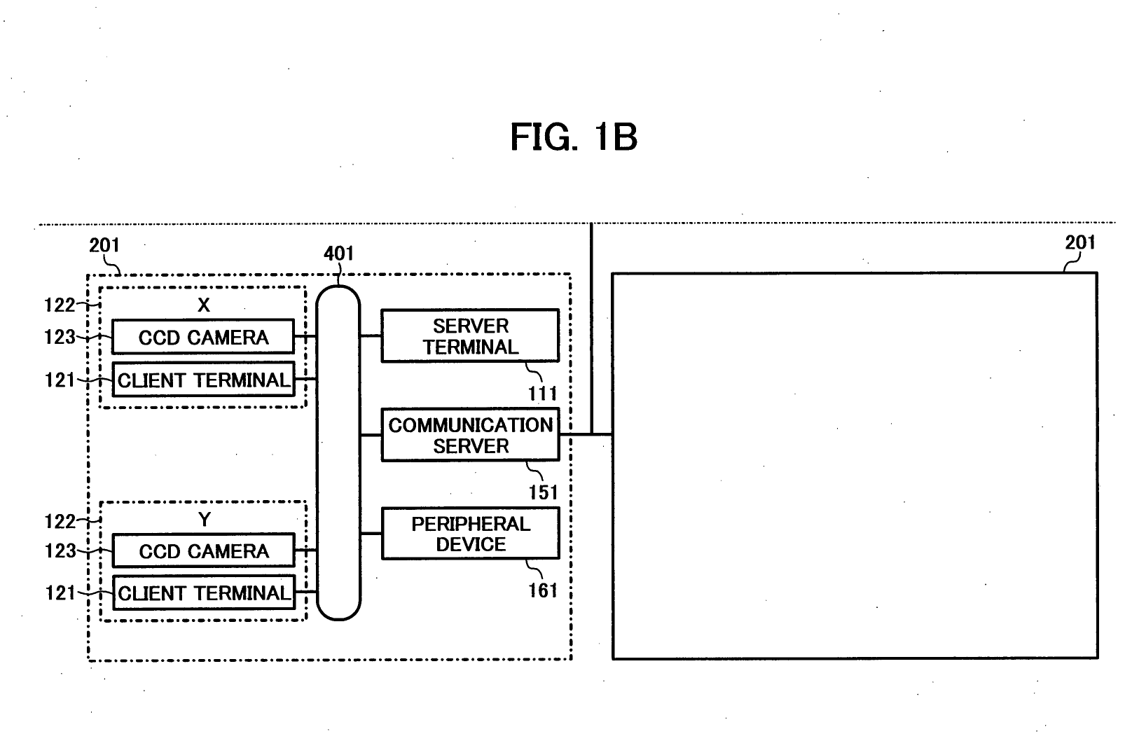

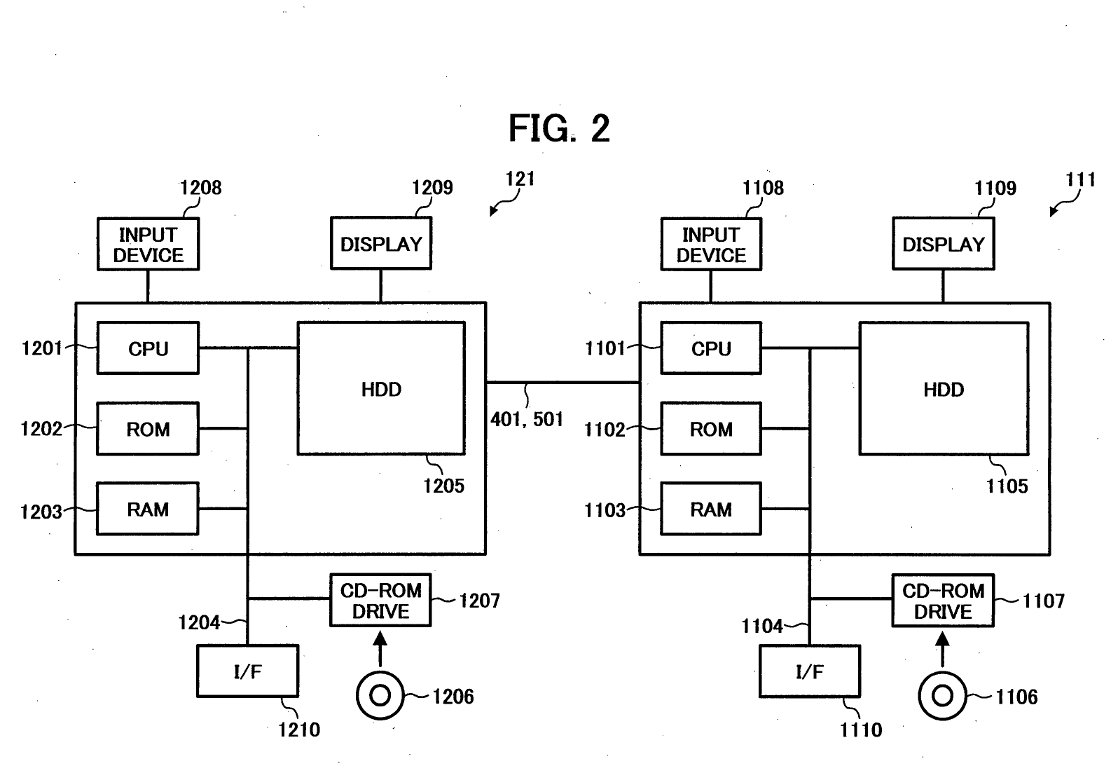

FIG. 2 is a block diagram illustrating exemplary hardware structures of the server terminal 111 and the client terminal 121.

The server terminal 111 includes a CPU (central processing unit) 1101, a ROM (read only memory) 1102, a RAM (random access memory) 1103, a bus 1104, a HDD (hard disk drive) 1105, a CD-ROM 1106, a CD-ROM drive 1107, an input device 1108, a display 1109, and an interface 1110.

The CPU 1101 controls an entire operation of the server terminal 111. The ROM 1102 includes any kind of non-volatile memory, capable of storing BIOS, for example. The RAM 1103 includes any kind of volatile memory, capable of storing variable data, and it serves as a work memory for the CPU 1101. The CPU 1101, the ROM 1102, and the RAM 1103, which are connected via the bus 1104, thus function as a microcomputer.

The HDD 1105 stores various computer programs or instructions, including a virtual office providing program of the present invention. The virtual office providing program is originally stored in the CD-ROM 1106, solely, or together with its related computer programs. When the CD-ROM 1106 is inserted in the CD-ROM drive 1107, the CD-ROM drive 1107 extracts the virtual office providing program. The CPU 1101 then installs the program onto the HDD 1105. Once it is installed, the program is copied from the HDD 1105 to the RAM 1103 to cause the CPU 1101 to perform an operation according to a preferred embodiment of the present invention. In other words, the RAM 1103, the HDD 1105, and the CD-ROM 1106 together function as a storage device, capable of storing various computer programs or instructions, including the virtual office providing program.

The HDD 1105 may additionally store data codes to be used by the virtual office providing program. The data codes include, for example, a list of commands that can be transmitted to the client terminal 121 for execution of the virtual office providing program.

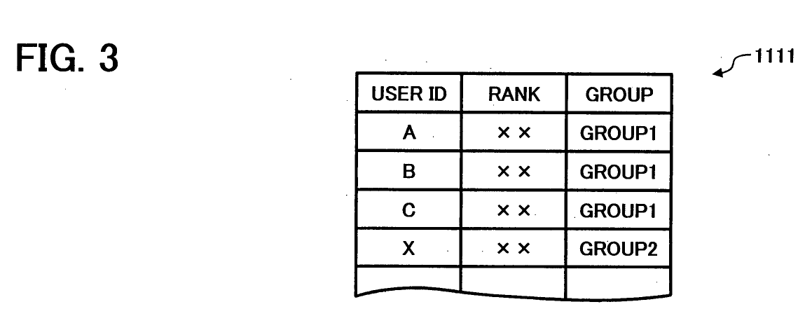

The HDD 1105 may also store a table, including identification information regarding users of the client terminals 121, such as user IDs, ranks, and groups of the respective users, as shown in FIG. 3. In this example, the user ID is a code uniquely assigned to each user of the client terminal 121. The rank is the position or role of the user in the company. The group is a group or team of the company that the user belongs to.

The input device 1108 includes a keyboard and a mouse, for example, capable of inputting commands. The display 1109 includes a CRT (cathode ray tube) monitor and a liquid crystal display, for example, capable of displaying the commands or data. Specifically, the display 1109 displays the virtual office created by the server terminal 111. The interface 1110 allows the server terminal 111 to communicate with another device, in this example, the client terminal 121, via the network 401. Examples of the interface 1110 include communications protocols, such as TCP/IP, however, the interface 1110 is not limited to this example. In other words, the interface 1110 may include hardware interfaces, such as plugs and sockets, in addition to the languages and codes needed to establish the communications between the server terminal 111 and the client terminal 121.

In an alternative to the CD-ROM 1106, any kind of storage medium may be applied, including, an optical disk such as a DVD, optical-magneto disk, a magnetic disk such as a flexible disk, a semiconductor device, etc.

Further, the virtual office providing program may be downloaded from other storage devices via the network 501, such as the Internet, to be installed onto the HDD 1105. In other words, the present invention may be applied to the storage device that is connected to the server terminal 111 via the network.

The virtual office providing program may operate on a predetermined operating system, and may further cause the operating system to perform various instructions according to a preferred embodiment of the present invention. Alternatively, the program may be included in a predetermined application program, such as word processing software, or it may be included in the operating system as a part of its program files.

The client terminal 121 includes a CPU 1201, a ROM 1202, a RAM 1203, a bus 1204, a HDD 1205, a CD-ROM 1206, a CD-ROM drive 1207, an input device 1208, a display 1209, and an interface 1210.

The CPU 1201 controls an entire operation of the client terminal 121. The ROM 1202 includes any kind of non-volatile memory, capable of storing BIOS, for example. The RAM 1203 includes any kind of volatile memory, capable of storing variable data, and it serves as a work memory for the CPU 1201.

The HDD 1205 stores various computer programs or instructions, including the virtual office providing program and a predetermined Internet browser. The virtual office providing program is installed in a similar manner as described above in the case of installing the virtual office providing program onto the HDD 1105. The Internet browser allows the client terminal 121 to browse various data transmitted from the server terminal 111, and it may be installed from the CD-ROM 1206, or may be installed via any other means, in a similar manner as described above in the case of installing the virtual office providing program onto the HDD 1105. Examples of such Internet browser include Internet Explorer (Internet Explorer is a registered trademark of the Microsoft Corporation) and the Netscape Communicator (Netscape Communicator is a registered trademark of the Netscape Communications Corporation). As described above, the CD-ROM 1206 is similar in structure to the CD-ROM 1106, except that it includes the Internet browser.

The CD-ROM drive 1207, the input device 1208, the display 1209, and the interface 1210 are similar in structure and function to the CD-ROM drive 1107, the input device 1108, the display 1109, and the interface 1110, respectively.

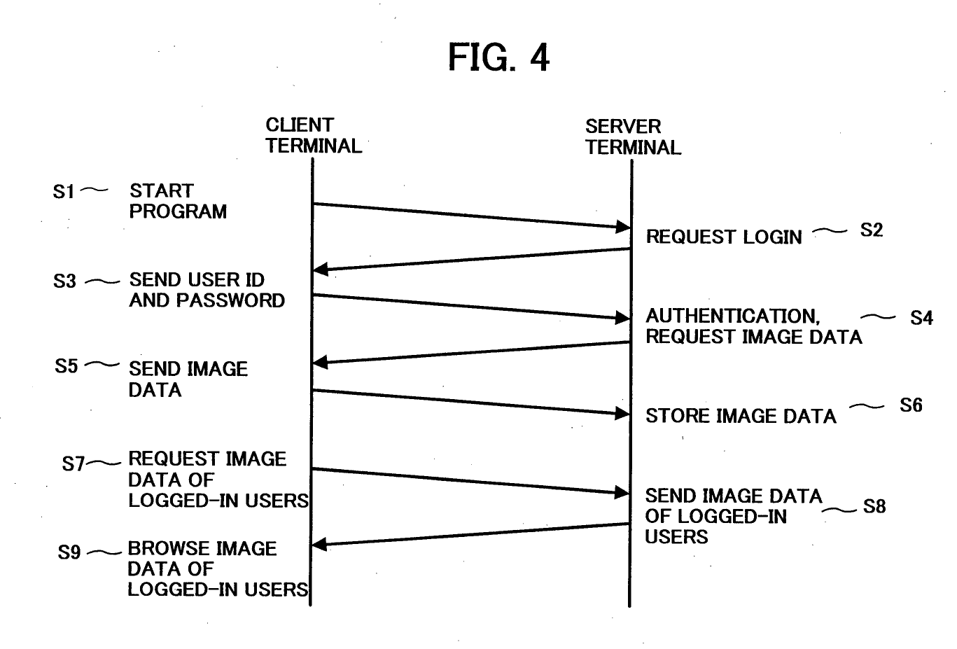

Referring now to FIG. 4, general steps included in an operation performed by the virtual office providing system 100 are explained. For the purpose of description, consider that the server terminal 111 of the main office 101, and the client terminal 121 assigned to users A and B, respectively, are in operation. The server terminal 111 and each of the client terminals 121 have structures substantially similar to those that are described referring to FIG. 2. Further, the following is described from the viewpoint of the client terminal 121 (hereinafter, referred to as the client terminal 121A) of the user A, however, the present invention is not limited to such example.

In Step S1, the client terminal 121A starts the virtual office providing program installed in the HDD 1205. By this starting process, the virtual office providing program is copied from the HDD 1205 onto the RAM 1203. Thus, the CPU 1201 of the client terminal 121A can access the RAM 1203 to perform an operation according to the virtual office providing program. Such an operation includes, for example, an operation of starting up the Internet browser and an operation of notifying the server terminal 111 that the virtual office providing program has been started. These operations may be performed automatically or manually by the user A.

To notify the server terminal 111, the client terminal 121A sends identification information, such as its IP address, to identify itself to the server terminal 111. Using this IP address, the server terminal 111 identifies the client terminal 121, specifically by looking up the table similar to the one shown in FIG. 3. In this case, the table includes at least the IP address and the user ID.

In Step S2, with the notification, the server terminal 111 provides a login menu to the client terminal 121A, requesting a user ID and a password. In this case, the login menu is provided by using the HTTP protocol, such that it can be interpreted by the Internet browser of the client terminal 121A.

In Step S3, the client terminal 121A inputs a specific user ID and a corresponding password, and sends such information to the server terminal 111.

In Step S4, the server terminal 111 authenticates the received user ID and the corresponding password, by looking up the table stored in the HDD 1105, which is similar to the one shown in FIG. 3. In this case, the table includes at least the user ID and the corresponding password. If they are authenticated, the server terminal 111 allows the client terminal 121A to log onto the virtual office. Otherwise, such an access is denied.

Subsequently, the server terminal 111 issues a request to the client terminal 121A for image data. In this case, the image data includes an image of the user A taken by the CCD camera 123.

In response to the request, in Step S5, the client terminal 121A sends the image data of the user A to the server terminal 111. More specifically, the client terminal 121A causes the CCD camera 123 to take an image of the user A according to the virtual office providing program.

In Step S6, the server terminal 111 stores the received image data in an image memory, provided in the RAM 1103.

Next, in Step S7, the client terminal 121A issues a request to the server terminal 111 for image data of logged-in users, that is, image data of all the employees who are working in the offices and who are currently logged into the virtual office. In this example, the image data of the logged-in users includes the image data of the user A and that of the user B. This operation may be performed automatically without user interaction or may be performed manually by the user A.

In Step S8, the server terminal 111 sends the client terminal 121A the image data of the logged-in users, that is, the image data of the user A and the image data of the user B, in a predetermined data format that can be read by the Internet browser of the client terminal 121A.

In Step S9, the client terminal 121A browses the image data of the logged-in users, which is displayed in the display 1209 as the virtual office, by using the Internet browser.

In a similar manner, the client terminal 121 of the user B can browse the image data of the logged-in users, which is displayed in the display 1209 as the virtual office, by using the Internet browser.

In other words, once they are logged into the virtual office, the users A and B can check the presence of the other or can share the virtual office, as if they were working in the same office environment.

In one example, the users A and B can communicate with each other in the virtual office in a real time environment, through means of videoconferencing, teleconferencing, and chatting, for example. In such cases, scripts for performing such synchronized communications are transmitted from the server terminal 111 to the respective client terminals 121, together with the image data of the logged-in users, in Step S8. The script is a list of commands that can be executed without user interaction, and includes, for example, the JavaScript (JavaScript is a registered trademark of Sun Microsystems, Inc.). After receiving the script, each of the client terminals 121 temporarily stores it in the RAM 1203 and performs an operation according to the data codes included in the script. In addition to the scripts for performing the synchronized communications, the server terminal 111 may provide the client terminal 121 with scripts for setting various rules of the synchronized communications operation.

Alternatively, computer programs may be previously installed in the HDD 1205 of each of the client terminals 121 to perform the synchronized communications operation. In such a case, the script is not sent from the server terminal 111 to the client terminals 121.

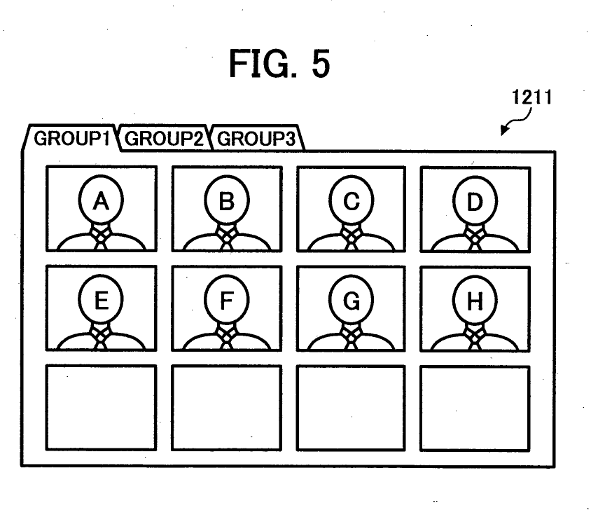

Referring now to FIGS. 5 to 25, operations of performing synchronized communications in a virtual office are explained according to preferred embodiments of the present invention.

The operations are performed by another virtual office providing system (not shown), including the server terminal 111 and the client terminals 121. In this specific example, the client terminals 121 at least include the client terminals 121 that are assigned to users A to H, respectively. Thus, a virtual office 1211 shown in FIG. 5, for example, may be displayed in the display 1209 of each of the client terminals 121.

The users A to H are assigned to the same group, “GROUP 1”, as shown in the group tab of FIG. 5. In addition to the GROUP 1, the virtual office 1211 includes “GROUP 2” and “GROUP 3”.

Here, the users A and B may be different from the users A and B of the previous example of FIGS. 1A and 1B, however, the client terminal 121 assigned to the user A or B is substantially similar to the one assigned to the user A or B of the previous example.

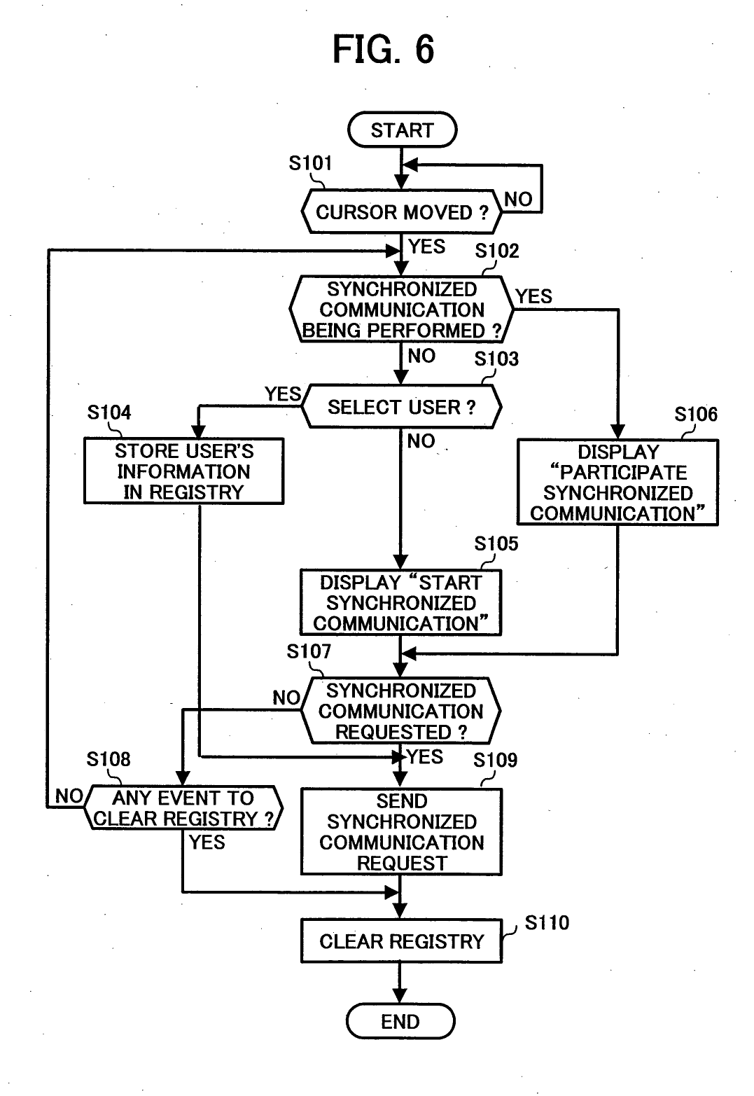

Referring to FIG. 6, an exemplary operation of requesting the synchronized communication performed by the client terminal 121 (hereinafter, referred to as the client terminal 121A) assigned to the user A is explained. As described above, this operation is performed according to the script transmitted from the server terminal 111 or the program having a similar function to the script.

The following is described from the viewpoint of the client terminal 121A, however, the present invention is not limited to such example. Further, the operation described in FIG. 6 corresponds to the operation described referring to Step S7 of FIG. 4.

Step S101 determines whether the user A wants to start synchronized communication with one of the users B to H. This may be done based on the movement of a cursor on the display.

For example, if the user A wants to communicate with the user B, the user A moves the cursor on the display 1209 by the mouse, for example, onto the image of the user B. Thus, if the cursor is not moved, the process repeats Step S101. If the cursor is moved, the process moves to Step S102 for further operations.

In another example, the user A may move the cursor onto a name of the user B, if it is displayed on the display 1209 as a part of the virtual office 1211.

In Step S102, the CPU 1201 of the client terminal 121A determines whether the client terminal 121 (hereinafter, referred to as the “client terminal 121B”) assigned to the user B is currently in communication with at least one of the other client terminals C to H, according to the script that has been sent from the server terminal 111.

Such determination may be made by referring to information regarding the other client terminals B to H, temporarily stored in the RAM 1203, for example, as the virtual office 1211. Such information is sent from the server terminal 111, which can easily obtain the information regarding the logged-in users A to H. If Step S102 determines that the client terminal 121B is not in communication, the process moves to Step S103 to select the user B as a communication partner. If Step S102 determines that the client terminal 121B is in communication, the process moves to Step S106 to display the message, “PARTICIPATE SYNCHRONIZED COMMUNICATION” in the display 1209 of the client terminal 121A.

Step S103 determines whether the user A has selected the user B by clicking the image or the name of the user B with the mouse. In this case, the user A presses the left button of the mouse once or twice. If the user B is selected, the process moves to Step S104 to copy identification information regarding the user B, such as its IP address, from the server terminal 111 to a registry of the RAM 1203 of the client terminal 121A.

If the image or name of the user B is not clicked, the process moves to Step S105.

In Step S105, the user A presses the right button of the mouse to display the message “START SYNCHRONIZED COMMUNICATION” on the display 1209.

Step S107 determines whether the synchronized communication has been requested.

In one example, the user A can select the message “START SYNCHRONIZED COMMUNICATION” displayed in Step S105, by moving the cursor and pressing the left button of the mouse. Then, it is determined that the user A has requested to start synchronized communication with the user B.

In another example, the user A can select the message “PARTICIPATE SYNCHRONIZED COMMUNICATION” displayed in Step S106, by moving the cursor and pressing the left button of the mouse. Then, it is determined that the user A has requested to participate in the synchronized communication that the user B is currently involved in.

Once the synchronized communication has been requested, the identification information regarding the user B, such as its IP address, is copied from the server terminal 111 to the registry of the client terminal 121. Then, the process moves to Step S109.

If Step S107 determines that the synchronized communication has not been requested, the process moves to Step S108 to determine whether any event has occurred, which requires clearing of the registry. If Step S108 determines that the event has occurred, the process moves to Step S110 to clear the registry, otherwise, the process moves to Step S102.

In Step S109, the client terminal 121A sends the synchronized communication request to the server terminal 111. In this step, the client terminal 121A also sends identification information regarding the user A, who is a requester, and the user B, who has been selected by the requester. Such identification information includes, for example, the IP addresses of the client terminals 121A and 121B, previously stored in the registry of the RAM 1203 of the client terminal 121A.

In Step S110, after the identification information has been sent to the client terminal 111, the information is cleared from the registry.

The information may be cleared from the registry, in other cases, such as when Step S108 determines that the event has occurred, as described above.

In the above example, the user A selects only the user B, i.e., a single user. However, the user A may select more than one user to request the synchronized communication with more than one user.

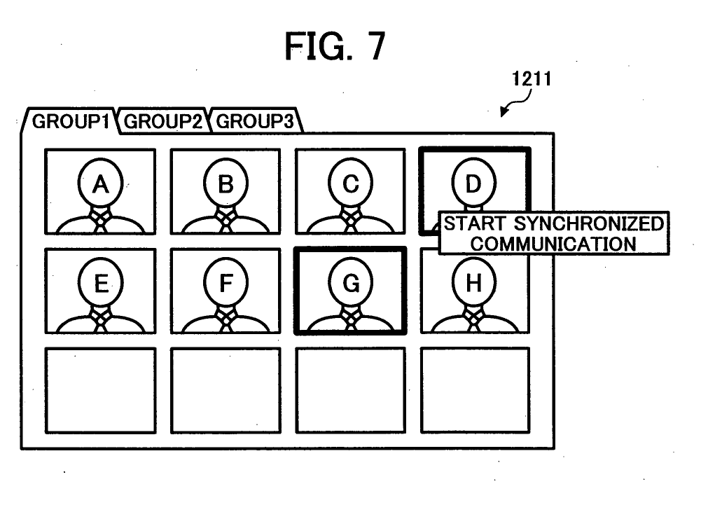

In one example, if the user A wants to communicate with the user D and the user G, the user A clicks on the image of the user D and the image of the user G, while pressing the CTRL key on the keyboard. After the selection, the border lines of the images of the users D and G may be highlighted or thickened to show which of the users A to H are selected, as shown in FIG. 7. The user A then presses the right button of the mouse to display the message “START SYNCHRONIZED COMMUNICATION”, as described above referring to Step S105.

In the above exemplary case, the user A may select a name of the user D and a name of the user G, if they are displayed on the display 1209, as a part of the virtual office 1211.

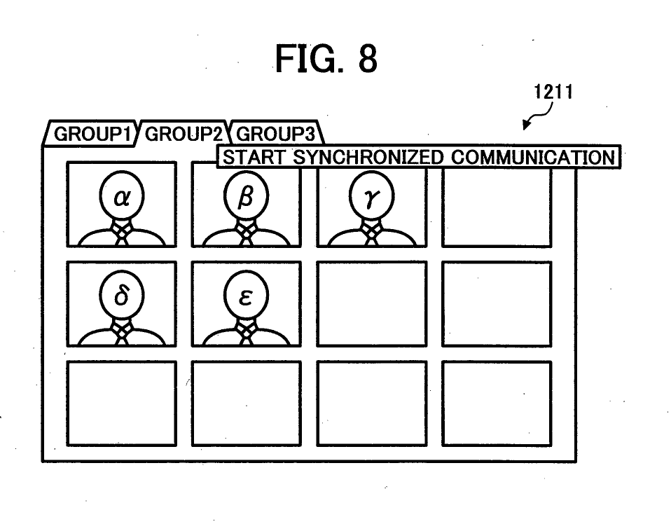

In another example, the user A may select a group of the users, by clicking on one of the group tabs displayed in the display 1209. FIG. 8 illustrates an exemplary displayed image when the “GROUP 2” is selected. When the user A moves the curser onto the group tab of “GROUP 2”, the message “START SYNCRHONIZED COMMUNICATION” is displayed. The user A can request the server terminal 111 to start synchronized communication with the group 2, by selecting this message with the left button of the mouse.

In such a case, the client terminal 121 sends information specifying the selected group, as the identification information, in Step S109. With this information, e server terminal 111 can identify which group has been selected, and can further identify the users in that group by referring to a table similar to the one shown in FIG. 3.

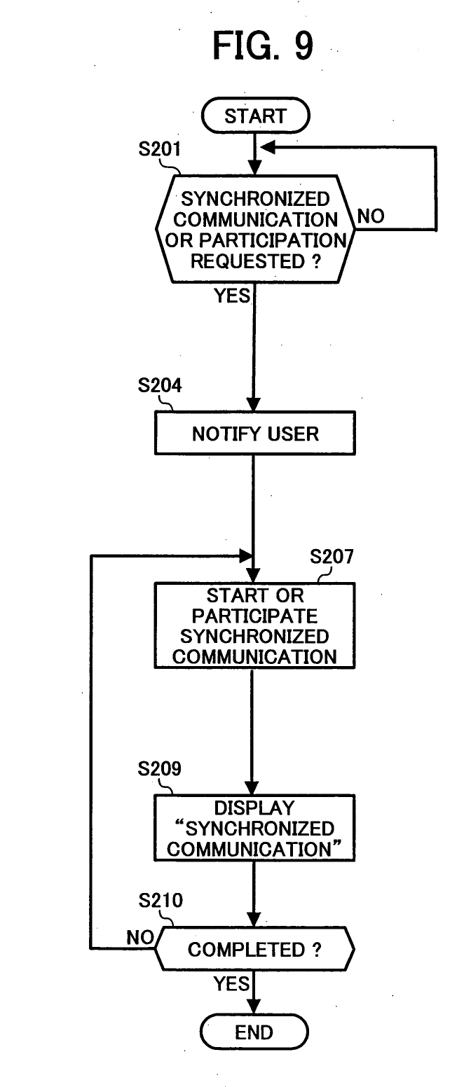

After the synchronization communication request has been sent, the server terminal 111 starts an operation of starting the synchronized communication operation, as described in FIG. 9.

The following describes the case of receiving a request from the client terminal 121A, however, the present invention is not limited to such example.

Step S201 determines whether the synchronized communication request has been sent from the client terminal 121A. If it is determined that the request has been sent, the process moves to Step S204, otherwise the process repeats Step S201. In this case, the synchronized communication request includes a request for starting the synchronized communication and a request for participating in the synchronized communication.

In Step S204, the server terminal 111 notifies the client terminal 121 of the user requested by the user A. If the user A requests to communicate with the user B, the server terminal 111 identifies the client terminal 121 of the user B by its identification information, such as the IP address, that has been sent from the client terminal 121A together with the request. Subsequently, the server terminal 111 notifies the user B that the request has been sent from the user B for synchronized communication.

In Step S207, the server terminal 111 allows the user A to start the synchronized communication with the user B or participate in the synchronized communication that the user B is currently involved in.

In Step S209, the server terminal 111 notifies all the logged-in users A to H that the users A and B have started the synchronized communication, or the user A has joined in the synchronized communication that the user B is currently involved in. Specifically, this is done by displaying such information on the respective displays 1209 of the client terminals 121 of the users A to H, as a part of the virtual office 1211.

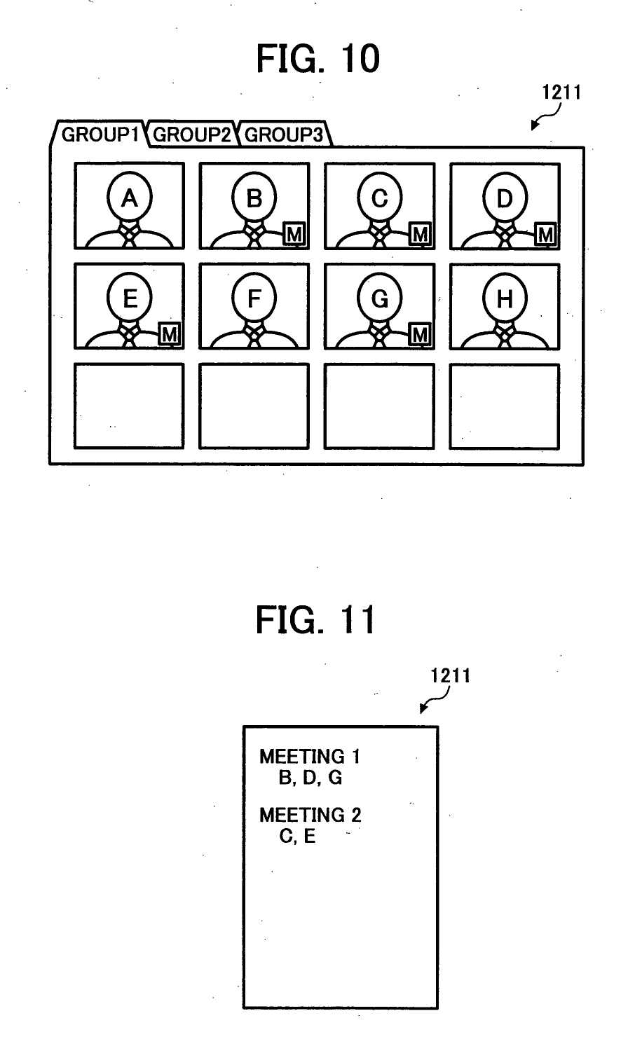

FIG. 10 illustrates an exemplary displayed image of an exemplary case, in which the users B, D, and G are communicating with one another in a meeting 1, and the users C and E are communicating with each other in another meeting 2. Here, “meeting” may be used interchangeably with “synchronized communication.”

As shown in FIG. 10, the image of a user currently involved in a meeting is marked with the “M” on its right corner.

FIG. 11 illustrates another exemplary displayed image of the above exemplary case. The image of FIG. 11 contains a list of the users currently involved in the meetings. In this case, the users B, D and G are listed under the meeting 1, while the users C and E are listed under the meeting 2. With this information, any of the logged-in users can clearly understand who is involved in which meeting.

The displayed images of FIGS. 10 and 11 may be displayed at the same time on the display 1209 as the virtual office 1211, or one of the images may be selected to display on the display 1209 as the virtual office 1211 according to the user's preference.

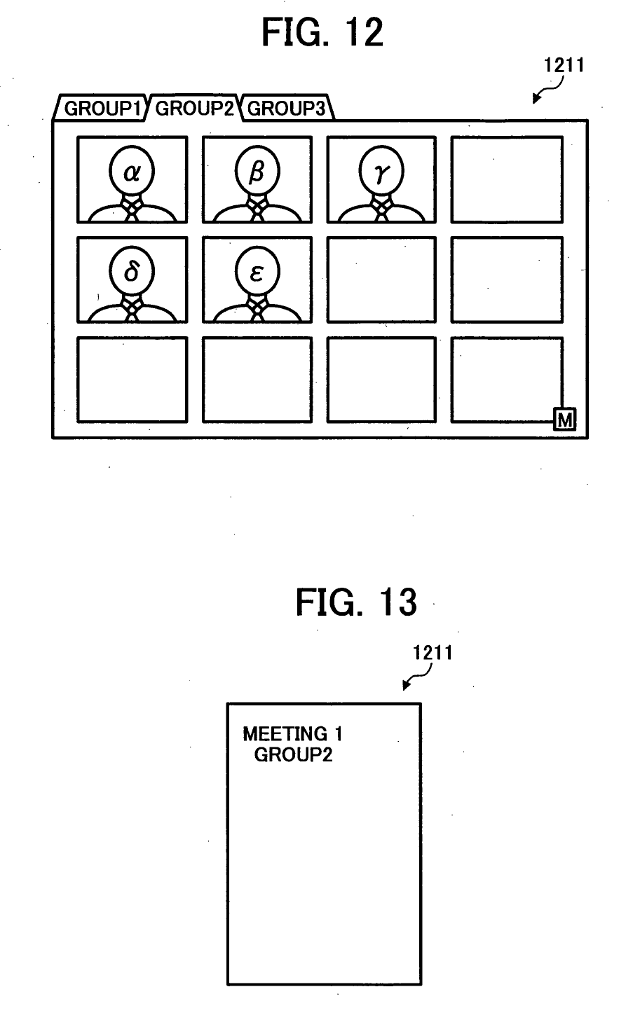

FIG. 12 illustrates an exemplary displayed image of another exemplary case, in which the users in the group 2 are communicating with one another in a meeting 1. As shown in FIG. 12, the image of the group 2 is marked with the “M” on its right corner.

FIG. 13 illustrates another exemplary displayed image of the above-described exemplary case of communicating in the group 2. In this case, the group 2 is listed under the meeting 1.

Again, the displayed images of FIGS. 12 and 13 may be displayed at the same time on the display 1209 as the virtual office 1211, or one of the images may be selected to display on the display 1209 as the virtual office 1211 according to the user's preference.

Next, Step S210 determines whether the synchronized communication has been completed. If the answer is yes, the process ends to complete the operation, otherwise, the process moves to Step S207 to repeat the Steps S207, S209 and S210.

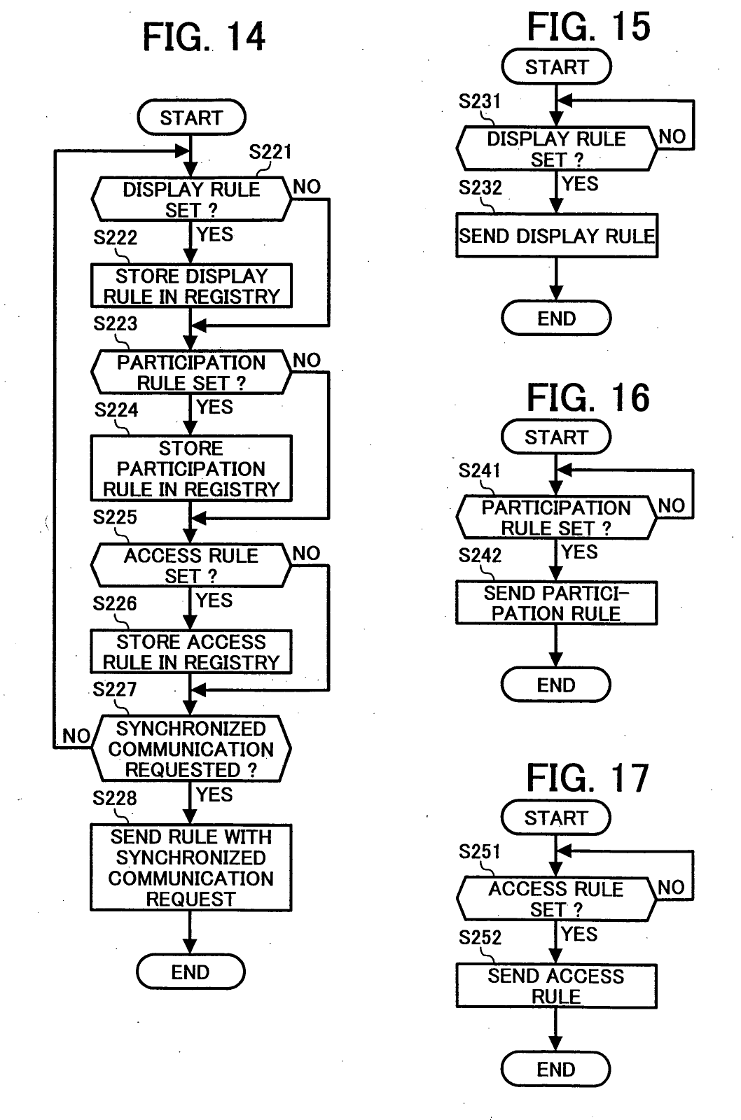

Referring now to FIG. 14, an exemplary operation of setting various rules performed by the client terminal 121A is explained. The following is described from the viewpoint of the client terminal 121A, however, the present invention is not limited to such example.

The operation shown in FIG. 14 is preferably performed before Step S107 of FIG. 6, which is substantially similar to Step S227 of FIG. 14. However, it is not limited to such exemplary case.

Step S221 determines whether a display rule has been set by the user A. The display rule corresponds to a rule regarding the display of virtual office 1211. If the display rule has been set, the process moves to Step S222 to store the display rule in a registry of the RAM 1203 of the client terminal 121A. Otherwise, the process moves directly to Step S223.

Next, Step S223 determines whether a participation rule has been set by the user A. The participation rule represents a rule regarding the participation in the synchronized communication. If the participation rule has been set, the process moves to Step S224 to store the participation rule in a registry of the RAM 1203 of the client terminal 121A. Otherwise, the process moves directly to Step S225.

Next, Step S225 determines whether an access rule has been set by the user A. The access rule represents a rule specifying whether the user displayed in the virtual office 1211 is available for synchronized communication. If the access rule has been set, the process moves to Step S226 to store the access rule in a registry of the RAM 1203 of the client terminal 121A. Otherwise, the process moves directly to Step S227.

After Step S227 determines that the synchronized communication has been requested by the client terminal 121A, the process moves to Step S228 to send all the rules stored in the RAM 1203 to the server terminal 111. In this example, the rules are preferably sent together with the synchronized communication request. In other words, Step S228 is performed simultaneously with Step S210 of FIG. 6. However, the rules may be sent at different times, independently of the synchronized communication request.

Further, in the above exemplary case, the display rule, the participation rule, and the access rule are subsequently or simultaneously set and stored in the RAM 1203, however, they may be set independently from each other, as shown in FIGS. 15 to 17.

In FIG. 15, Step S231 determines whether the display rule has been set by the user A. If the answer is yes, the process moves to Step S232 to immediately send the display rule to the server terminal 111.

In FIG. 16, Step S241 determines whether the participation rule has been set by the user A. If the answer is yes, the process moves to Step S242 to immediately send the participation rule to the server terminal 111.

In FIG. 17, Step S251 determines whether the access rule has been set by the user A. If the answer is yes, the process moves to Step S252 to immediately send the access rule to the server terminal 111.

Further, it is not necessary to set all the rules as described above referring to FIG. 14. In other words, the client terminal 121A may set at least one of the rules, or may set none of the rules, to perform the synchronized communication operation.

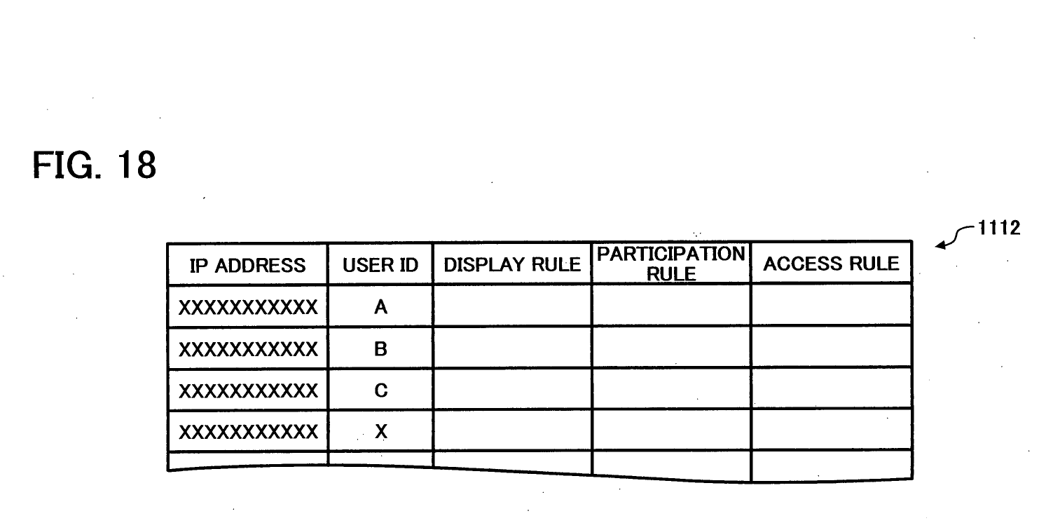

After the rules have been sent from the client terminal 121A, the server terminal 111 creates a table 1112 in a work memory of the RAM 1103. FIG. 18 illustrates an exemplary structure of the table 1112. The table 1112 of FIG. 18 includes classification of IP address, user ID, display rule, participation rule, and access rule. The IP address has been previously sent from the client terminal 121 to the server terminal 111, when the client terminal 121 starts the virtual office providing program. The user ID of the table 1112 preferably matches with the user ID of the table 1111 shown in FIG. 3. If they are not matched, information to link the user ID of the table 1111 and the user ID of the table 1112 is necessary.

With the tables 1111 and 1112, the server terminal 111 can extract various information regarding the respective users. Such information can be effectively used to control the synchronized communication operation, as described below.

In one example of controlling the synchronized communication, the client terminal 121 can control the display of the information in the virtual office, using the display rule.

As described above, with the display of the information regarding the synchronized communication, the logged-in users can clearly know who is involved in which meeting. However, there may be a case, in which the meeting must be confidential. In such a case, the users involved in the confidential meeting may ask the server terminal 111 to conceal such information from a certain number of the users, or not to display such information at all, by setting the display rule or a rank rule.

The display rule defines the amount of information that can be displayed to the logged-in users, as mentioned above. For example, the display rule may be previously set such that the information regarding a specific confidential meeting is not displayed in the displays 1209 of the client terminals 121 of all the logged-in users. In another example, the display rule may be previously set such that the information regarding a specific confidential meeting is not displayed in the displays 1209 of the client terminals 121 of the selected users.

The rank rule corresponds to the user's authority level in the virtual office, in relationship with the rank of the user. In this example, the user rule defines the amount of information that can be displayed to the user of the client terminal 121, in relationship with the rank of the user. For example, the rank rule can specify that the information regarding all the meetings performed by the users of higher ranks is not displayed in the displays 1209 of the client terminals 121 of the users of lower ranks. In such a case, the rank rule is previously stored in the HDD 1105 of the server terminal 111, and copied to the RAM 1103 when the virtual office providing program is started. When the synchronized communication has been started among the users of higher ranks, for example, the server terminal 111 can check the rank rule and the table similar to the one shown in FIG. 3. With this information regarding the users, the corresponding ranks, and the rank rule, the server terminal 111 can determine the users to which it should display the information regarding the communication.

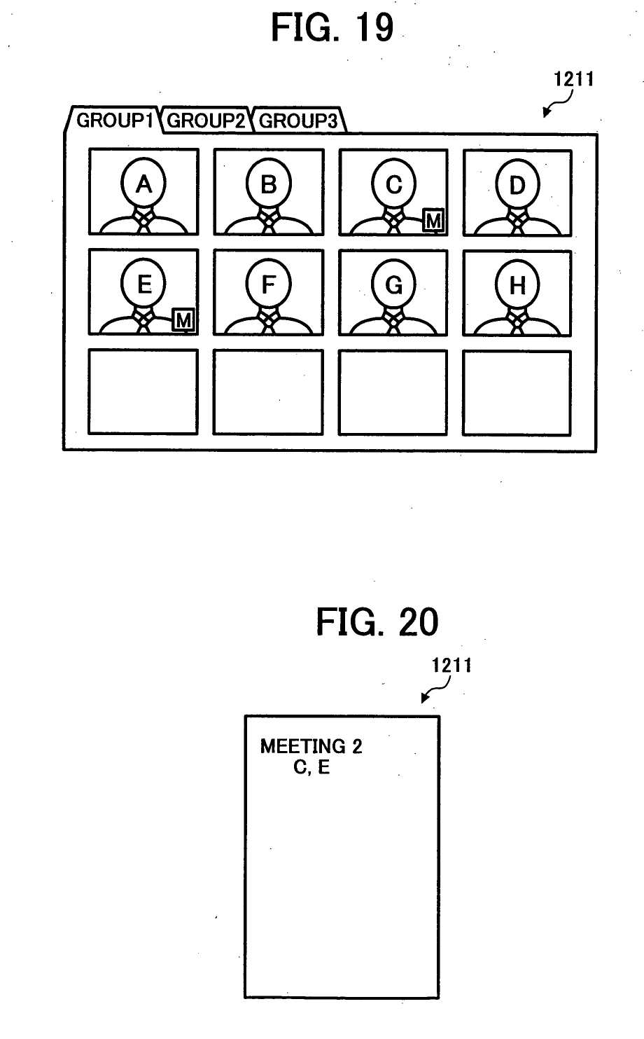

FIG. 19 illustrates an exemplary displayed image of the exemplary case shown in FIG. 10. In this case, however, the meeting 1 held by the users B, D, and G is treated as confidential. Thus, the marks M assigned to the users B, D and G, which are shown in FIG. 10, are not shown in FIG. 19.

FIG. 20 illustrates another exemplary displayed image of the above exemplary case, in which the meeting 1 is confidential. The meeting 1 and the users B, D, and G listed under the meeting 1, which are shown in FIG. 11, are not shown in FIG. 20.

In the above exemplary cases of FIGS. 19 and 20, the users B, D, and G may be of higher ranks, such that information regarding this confidential meeting is concealed from the users A, C, E, F, and H of lower ranks. Alternatively, the users B, D, and G may have decided to make the meeting 1 confidential to all other logged-in users.

In another example of controlling the synchronized communication, the client terminal 121 can control the participation of the user in the synchronized communication, using the participation rule.

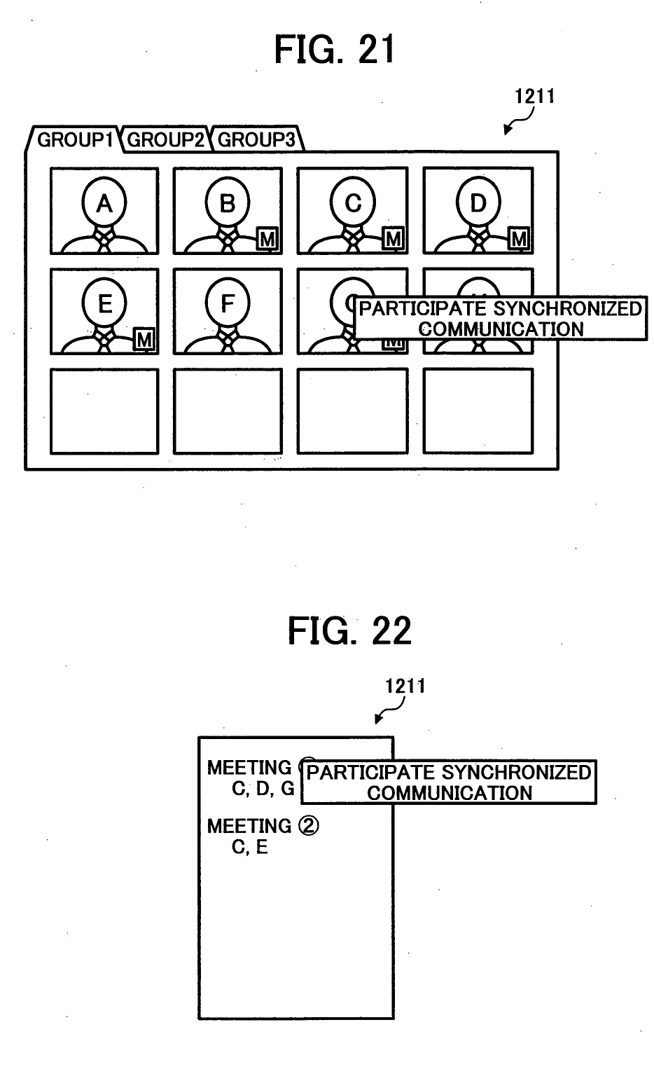

FIG. 21 illustrates an exemplary displayed image of an exemplary case, in which the user A wants to participate in a meeting 1, currently held by the users B, D, and G. If the user A moves the curser to one of the images of the users B, D, and G, the message “PARTICIPATE SYNCHRONIZED COMMUNICATION” is displayed in the display 1209, as shown in FIG. 21. By clicking on the displayed message, the user A can participate in the meeting 1.

FIG. 22 illustrates another exemplary displayed image of the above exemplary case. The image of FIG. 22 contains a list of the users currently involved in the meetings. The users B, D, and G are listed under the meeting 1. If the user A moves the cursor onto the list, the message “PARTICIPATE SYNCHRONIZED COMMUNICATION” is displayed in the display 1209. By clicking on the displayed message, the user A can participate in the meeting 1.

However, if the meeting 1 held by the users B, D, and G should be confidential to any other users, or it should be confidential to the users of lower ranks, the participation may be controlled, using the participation rule or the rank rule.

The participation rule defines whether the user can participate in the synchronized communication. For example, the participation rule may be set such that the participation in a specific confidential meeting is not allowed for all the logged-in users.

Alternatively, the participation rule may be set such that the participation in a specific confidential meeting is not allowed for the selected users, such as the users of lower ranks. In such a case, the participation rule needs information regarding the ranks of the respective users such that it has a function substantially similar to that of the rank rule. Thus, the rank rule may be applied to control the participation.

By referring to the participation rule, the server terminal 111 automatically prevents the selected users from participating in the meeting.

Further, the participation rule may be set previously or each time the request for participation is transmitted from the user. For example, after the user A has clicked on the message shown in FIG. 21, at least one of the users B, D, and G can decide whether the user A can participate in the meeting 1.

In another example of controlling the synchronized communication operation, the client terminal 121 can control the access to the respective users displayed in the virtual office, using the access rule.

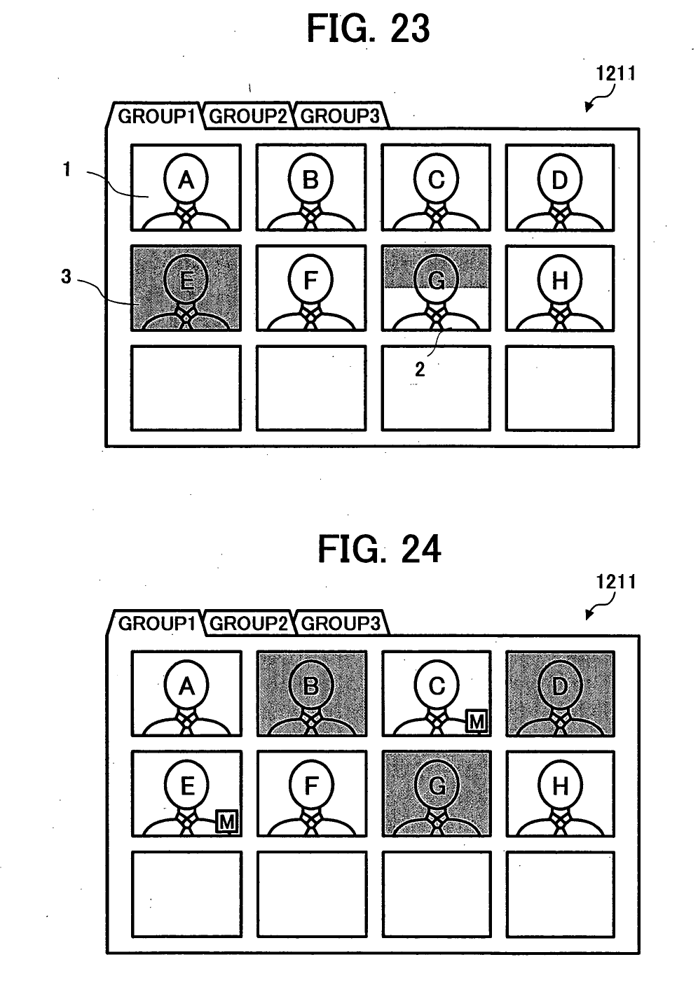

For example, there may be a time when the user of the client terminal 121 is not available for synchronized communication for some reasons. In such a case, the user can display the availability in the virtual office 1211, as shown in FIG. 23. In this example, three levels of availability are shown, including the levels 1, 2, and 3. The level 1 corresponds to the user who will accept any request, and is displayed as the image having a regular background. The level 2 corresponds to the user who is busy but may be available for communication, if such communication is important to the requester. The level 2 is displayed as the image of the user G in FIG. 23, in which the upper portion is darkened or marked. The level 3 corresponds to the user who is busy and not available at all for communication. The level 3 is displayed as the image of the user E in FIG. 23, in which the entire portion is darkened or marked.

Setting of the availability levels may be preferably applied to the case when the users are having a confidential meeting.

FIG. 24 illustrates an exemplary displayed image of the case, in which the users B. G, and D are involved in the confidential meeting. However, instead of just eliminating the M marks as shown in FIG. 19, the images of the users B, G, and D are darkened, indicating that they are unavailable to communicate.

In this way, even if the user A wants to communicate with the user B, for example, the user A decides not to communicate with the user B, since the user A can see that the user B is not available.

On the other hand, if the user A has the display shown in FIG. 19, the user A has no idea of what the user B is doing, and may request that the server terminal 111 start communication with the user B.

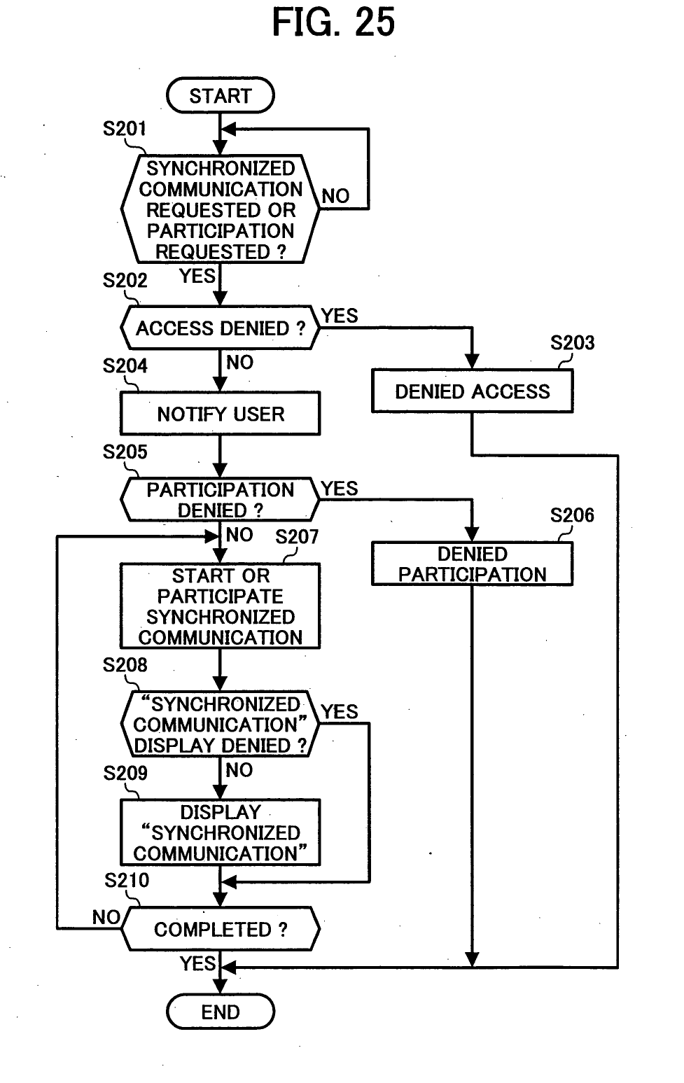

Referring now to FIG. 25, another exemplary operation of starting the synchronized communication operation performed by the server terminal 111 is explained. The following describes the case of receiving a request from the client terminal 121A, however, this operation is not limited to such example.

As shown in FIG. 25, the operations performed in Steps S201, S204, S207, S209, and S209 are substantially similar to the corresponding steps of FIG. 9.

After Step S201 determines that the synchronized communication has been requested, the process moves to Step S202. In this example, it is assumed that the user A wants to communicate with the user B.

Step S202 determines whether the access to the user B is denied. In one example, the server terminal 111 checks the availability of the user B, by referring to the access rule of the user B stored in a table similar to the one shown in FIG. 18. If the access rule of the user B is set such that the user B is not available for communication (corresponding to the level 3), the process moves to Step S203 to refuse the synchronized communication. If the access rule of the user B is set such that the user B is available for communication (corresponding to the level 1 or 2), the process moves to Step S204 to notify the user A of the user B's availability.

Step S205 determines whether the user A is allowed to participate in the synchronized communication that the user B is currently involved in. More specifically, the server terminal 111 checks the participation rule or the rank rule, which have been previously stored in a table similar to the one shown in FIG. 18. If the user A is allowed to participate in the communication, the process moves to Step S207, otherwise, the process moves to Step S206 to deny the request from the user A.

Step S207 allows the user A to start the synchronized communication with the user B, or to join in the synchronized communication that the user B is currently involved in.

Step S208 determines whether the display of information regarding the synchronized communication is allowed. Specifically, the server terminal 111 checks the display rule or the rank rule, which have been previously stored in a table similar to the one shown in FIG. 18. If the display of information is allowed, the process moves to Step S210 to display the information, otherwise, the process moves directly to Step S210 to determine whether the synchronized communication has completed.

Numerous additional modifications and variations are possible in light of the above teachings. It is therefore to be understood that within the scope of the appended claims, the disclosure of this patent specification may be practiced otherwise than as specifically described herein.

For example, elements and/or features of different illustrative embodiments may be combined with each other and/or substituted for each other within the scope of this disclosure and appended claims.

Further, various messages displayed on the display of the client terminal 121 may contain different phrases or may be displayed in different ways.

Furthermore, the system or apparatus of the present invention is not limited to the system or apparatus described in this specification. They may vary, depending on means of synchronized communications, including, for example, videoconferencing, teleconference, and chatting, or the structure of the company.

This patent specification is based on Japanese patent application, No. JPAP2003-299235 filed on Aug. 22, 2003, in the Japanese Patent Office, the entire contents of which are incorporated by reference herein.

1. An apparatus, comprising:
a processor;
a photographing device;
a storage device configured to store identification information of users, and a plurality of instructions which, when executed by the processor, cause the processor to perform a programmed operation including:
starting a network browser;
identifying users using the processor, based on the identification information;
taking images of the users, using the photographing device; and
creating a virtual office on a network accessible by the users;
at least one input device configured to allow the users to input commands to the processor;
a display configured to represent the virtual office to the users, by displaying the images of the users in a format readable to the network browser; and
a communications interface configured to connect the processor to the network.

2. The apparatus of claim 1, wherein the processor comprises a central processing unit and a memory.

3. The apparatus of claim 1, wherein the storage device comprises a hard disk drive, a recording medium, and a memory.

4. The apparatus of claim 1, wherein the network includes the Internet.

5. The apparatus of claim 1, wherein the identification information comprises user IDs of the respective users and their corresponding passwords.

6. The apparatus of claim 1, wherein the programmed operation further includes:
a first user selecting a second user from the display;
starting synchronized communication between the first and second users; and
displaying a message indicating that the synchronized communication has started.

7. The apparatus of claim 6, wherein the second user includes more than one user using the processor.

8. The apparatus of claim 6, wherein the starting operation includes one of:
establishing synchronized communication between the first user and the second user; and
joining the first user into synchronized communication that the second user is currently involved in.

9. The apparatus of claim 6, wherein the message includes at least one of:
a mark placed on the images of the first and second users; and
a user list indicating the first and second users, displayed on a portion of the display, other than the portion having the images of the users.

10. The apparatus of claim 5, wherein the identification data further comprises information regarding IP addresses of the respective users and user groups that the respective users belong to, with the information regarding user groups is displayed on the display as a part of the virtual office.

11. The apparatus of claim 10, wherein the programmed operation further includes:
selecting one of the user groups, by using the information regarding user groups;
starting synchronized communication between a first user and the selected user group; and
displaying a message indicating that the synchronized communication has started.

12. The apparatus of claim 11, wherein the starting operation includes one of:
establishing synchronized communication between the first user and the selected user group; and
joining the first user into the synchronized communication that the user group is currently involved in.

13. The apparatus of claim 12, wherein the starting operation is performed according to a rule previously set by the selected user group.

14. The apparatus of claim 13, wherein the rule includes at least one of:
an access rule specifying whether the selected user group is available for synchronized communication;
a participation rule specifying whether the first user can join in synchronized communication of the selected user group; and
a rank rule specifying an authority level of the first user, in relationship with the rank of the first user and the rank of the selected user group.

15. The apparatus of claim 11, wherein the message includes at least one of:
a mark placed on the images of the users; and
a user list indicating the user group, displayed on another portion of the display, other than the portion having the images of the users.

16. The apparatus of claim 11, wherein the displaying operation is performed according to a display rule, with the display rule specifying whether the message can be displayed.

17. The apparatus of claim 5, wherein the identification information further comprises information regarding IP addresses of the respective users, ranks of the respective users, and access rules previously set by the respective users.

18. The apparatus of claim 17, wherein the programmed operation further includes:
a first user selecting a a second user from the display;
determining availability of the second user;
starting synchronized communication between the first and second users, based on the availability; and
displaying a message indicating that the synchronized communication has started.

19. The apparatus of claim 18, wherein the availability is determined according to the access rule of the second user, indicating whether the second user is available for the synchronized communication.

20. The apparatus of claim 19, wherein the access rule includes three levels of availability, including:
a first level, in which the first and second users can start the synchronized communication;
a second level, in which the first and second users may start the synchronized communication, if such communication is important; and
a third level, in which the first and second users may not start the synchronized communication.

21. The apparatus of claim 18, wherein the availability is determined according to a rank rule, with the rank rule corresponding to a relationship between the rank of the first user and the rank of the second user.

22. The apparatus of claim 18, wherein the second user includes more than one user using the processor.

23. The apparatus of claim 18, wherein the message includes at least one of:
a mark placed on the images of the first and second users; and
a user list indicating the first and second users, displayed on a portion of the display, other than the portion having the images of the users.

24. The apparatus of claim 5, wherein the identification information further comprises information regarding IP addresses of the respective users, ranks of the respective users, and display rules previously set by the respective users.

25. The apparatus of claim 24, wherein the programmed operation further includes:
a first user selecting a second user from the display;
starting synchronized communication between the first and second users;
determining whether a message can be displayed on the display to indicate that the synchronized communication has started; and
displaying the message, based on the determination result.

26. The apparatus of claim 25, wherein the determining operation uses the display rules of the first and second users, with the display rules indicating whether the message can be displayed on the display.

27. The apparatus of claim 25, wherein the determining operation uses a rank rule, with the rank rule corresponding to a relationship between the rank of the first user and the rank of the second user.

28. The apparatus of claim 25, wherein the second user includes more than one user using the processor.

29. The apparatus of claim 25, wherein the message includes at least one of:
a mark placed on the images of the first and second users; and
a user list indicating the first and second users, displayed in a portion of the display, other than the portion having the images of the users.

30. The apparatus of claim 5, wherein the identification information further comprises information regarding IP addresses of the respective users, ranks of the respective users, and participation rules previously set by the respective users.

31. The apparatus of claim 30, wherein the programmed operation further comprises:
a first user selecting a second user from the display, with the second user being currently involved in synchronized communication;
determining whether the first user can join in the synchronized communication;
joining the first user in the synchronized communication, based on the determination result; and
displaying a message indicating that the first user has joined in the synchronized communication.

32. The apparatus of claim 31, wherein the determining operation uses the participation rules of the first and second users, indicating whether the first user can join in the synchronized communication.

33. The apparatus of claim 31, wherein the determining operation uses a rank rule, with the rank rule corresponding to a relationship between the rank of the first user and the rank of the second user.

34. The apparatus of claim 31, wherein the second user includes more than one user using the processor.

35. The apparatus of claim 31, wherein the message includes at least one of:
a mark placed on the images of the first and second users; and
a user list indicating the first and second users, displayed in a portion of the display, other than the portion having the images of the users.

36. A system, comprising:
a server terminal;
first client terminals connected to the server terminal via a network;
a second client terminal connected to the server terminal via the network;
wherein the server terminal comprises:
a first processor;
a first storage device storing first data received from the first client terminals, and a plurality of instructions which, when executed by the first processor, cause the first processor to perform a server operation including:
querying the second client terminal for login information;
authenticating the second client terminal based on the login information;
querying the second client terminal for second data, if authenticated in the authenticating operation;
storing the second data received from the second client terminal in the storage device;
combining the second data of the second client terminal with the first data of the first client terminals to create a virtual office on the network; and
providing the virtual office to the second client terminal, in a format readable to the second client terminal;
and wherein the second client terminal comprises:
a second processor;
a display;
an input device configured to input a command to the second processor; and
a second storage device, storing a plurality of instructions which, when executed by the second processor, cause the second processor to perform a client operation including:
sending the login information to the server terminal;
sending the second data to the server terminal;
requesting the server terminal for the virtual office; and
displaying the virtual office on the display, using a browser.

37. The system of claim 36, wherein the login information includes a user ID of a user using the second terminal and its corresponding password.

38. The system of claim 36, wherein the plurality of instructions stored in the second processor includes a script transmitted from the first processor.

39. The system of claim 36, wherein the server operation further comprises:
providing a script to the second client terminal for requesting to set a rule regarding the virtual office; and
storing the rule received, from the second client terminal in the storage device, and wherein the client operation further comprises:
sending the rule set according to the script to the server terminal.

40. The system of claim 39, wherein the first data includes images of respective users using the first client terminals, and the second data includes an image of a user using the second client terminal.

41. The system of claim 39, wherein the first data includes names of respective users using the first client terminals, and the second data includes a name of a user using the second client terminal.

42. The system of claim 39, wherein the first data includes user groups that users using the second client terminals belong to.

43. The system of claim 40, wherein the client operation further comprises:
selecting at least one of the images of the users using the second client terminals, with the input device, for synchronized communication; and
sending a synchronized communication request to the server terminal.

44. The system of claim 43, wherein the server operation further comprises:
displaying a message of confirming the selection made by the second client terminal.

45. The system of claim 44, wherein the server terminal further comprises:
allowing the client terminal to start the synchronized communication, according to the rule,
and wherein the client operation further comprises:
displaying a predetermined mark on the images selected in the selecting operation, indicating that the synchronized communication has started, according to the rule.

46. The system of claim 45, wherein the rule includes at least one of:
an access rule specifying whether the users of the first and second client terminals are available for synchronized communication;
a participation rule specifying whether the user of the second terminal can join in synchronized communication that the users of the first client terminals are involved in;
a display rule specifying whether the predetermined mark can be displayed, indicating that the synchronized communication has started; and
a rank rule specifying a relationship between a rank of the user using the second client terminal and ranks of the users using the first client terminals.

47. The system of claim 41, wherein the client operation further comprises:
selecting at least one of the names of the users using the second client terminals, with the input device, for synchronized communication; and
sending a synchronized communication request to the server terminal.

48. The system of claim 47, wherein the server operation further comprises:
displaying a message of confirming the second client terminal for the selection.

49. The system of claim 48, wherein the server operation further comprises:
allowing the client terminal to start the synchronized communication, according to the rule, and wherein the client operation further comprises:
displaying a predetermined message near the names selected in the selecting operation, indicating that the synchronized communication has started, according to the rule.

50. The system of claim 49, wherein the rule includes at least one of:
an access rule specifying whether the users of the first and second client terminals are available for synchronized communication;
a participation rule specifying whether the user of the second terminal can join in synchronized communication that the users of the first client terminals are involved in;
a display rule specifying whether the predetermined message can be displayed, indicating that the synchronized communication has started; and
a rank rule specifying a relationship between a rank of the user using the second client terminal and ranks of the users using the first client terminals.

51. The system of claim 42, wherein the client operation further comprises:
selecting at least one of the user groups of the users using the second client terminals, with the input device, for synchronized communication; and
sending a synchronized communication request to the server terminal.

52. The system of claim 51, wherein the server operation further comprises:
displaying a message of confirming the second client terminal for the selection.

53. The system of claim 52, wherein the server terminal further comprises:
allowing the client terminal to start the synchronized communication, according to the rule,
and wherein the client operation further comprises:
displaying a predetermined mark on the user group selected in the selecting operation, indicating that the synchronized communication has started, according to the rule.

54. The system of claim 53, wherein the rule includes at least one of:
an access rule specifying whether the users of the first and second client terminals are available for synchronized communication;
a participation rule specifying whether the user of the second terminal can join in synchronized communication that the users of the first client terminals are involved in;
a display rule specifying whether the predetermined mark can be displayed, indicating that the synchronized communication has started; and
a rank rule specifying a relationship between a rank of the user using the second client terminal and ranks of the users using the first client terminals.

55. A method, comprising the steps of:
sending identification information of users to a server terminal;
logging the users on a network, if the server terminal authenticates the users;
obtaining images of the users, using means for photographing;
storing the images of the users in a storage device of the server terminal;
creating a virtual office, using the images of the users and the identification information;
displaying the virtual office to the users; and
providing the users with an experience of the virtual office, using browsers and input devices both previously provided to the respective client terminals.

56. The method of claim 55, wherein the identification information includes user IDs uniquely assigned to the respective users, ranks of the users, user groups that the respective users belong to, and IP addresses uniquely assigned to the respective users.

57. The method of claim 56, wherein the virtual office includes at least one of:
a first portion having the images of the users;
a second portion having a list of names of the users; and
a third portion having a user group tab, indicating the user groups of the users.

58. The method of claim 57, further comprising the steps of:
recognizing a first user from the users, when the first user selects one or more second users from the users with the input device of the first user;
displaying information confirming the selection made by the first user, according to a movement of the input device;
receiving a synchronized communication request from the first user;
notifying the one or more second users of the synchronized communication request being received;
starting synchronized communication between the first user and the one or more second users; and
displaying information indicating that the synchronized communication has started.

59. The method of claim 58, wherein the synchronized communication request includes one of:
a request for starting synchronized communication between the first user and the one or more second users; and
a request for joining in synchronized communication that the one or more second users are currently involved in.

60. The method of claim 59, wherein the recognizing step recognizes when the first user selects the first portion of the virtual office.

61. The method of claim 59, wherein the recognizing step recognizes when the first user selects the second portion of the virtual office.

62. The method of claim 59, wherein the recognizing step recognizes when the first user selects the third portion of the virtual office, with the one or more second users belonging to a same user group.

63. The method of claim 59, wherein the identification information further includes a rule controlling an operation in the virtual office.

64. The method of claim 63, wherein the rule includes at least one of:
an access rule specifying whether the users are available for synchronized communication;
a participation rule specifying whether the first user can join in synchronized communication that the one or more users are involved in;
a display rule specifying whether the information of the displaying step can be displayed, indicating that the synchronized communication has started; and
a rank rule specifying an authentication level of the users, in relationship with the ranks of the users.

65. The method of claim 64, further comprising the steps of:
determining whether the one or more second users are available for synchronized communication according to at least one of the access rule and the rank rule,
wherein the starting step is performed only when the determining step indicates that the one or more second users are available.

66. The method of claim 64, further comprising the steps of:
determining whether the one or more second users are available for synchronized communication according to at least one of the participation rule and the rank rule,
wherein the starting step is performed only when the determining step indicates that the one or more second users are available.

67. The method of claim 64, further comprising the steps of:
determining whether the information indicating that the synchronized communication has started is displayable, according to at least one of the display rule and the rank rule,
wherein the displaying step is performed only when the determining step indicates that the information is displayable.

68. The method of claim 58, wherein the information includes at least one of:
a mark placed on the first portion of virtual office;
a phrase placed on the second portion of the virtual office; and
another mark placed on the third portion of virtual office.

69. A computer program product stored on a computer readable storage medium for carrying out a method, when run on an apparatus, the method comprising the steps of:
sending identification information of users to a server terminal;
logging the users on a network, if the server terminal authenticates the users;
obtaining images of the users, using means for photographing;
storing the images of the users in a storage device of the server terminal;
creating a virtual office, using the images of the users and the identification information;
displaying the virtual office to the users; and
providing the users with an experience of the virtual office, using browsers and input devices both previously provided to the respective client terminals.

70. The product of claim 69, the method further comprising the steps of:
recognizing a first user from the users, when the first user selects one or more second users from the users with the input device of the first user;
displaying information confirming the selection made by the first user, according to a movement of the input device;
receiving a synchronized communication request from the first user;
notifying the one or more second users of the synchronized communication request being received;
starting synchronized communication between the first user and the one or more second users; and
displaying information indicating that the synchronized communication has started.

71. The product of claim 70, the method further comprising the steps of:
determining whether the one or more second users are available for synchronized communication according to a rule previously set by the users,
wherein the starting step is performed only when the determining step indicates that the one or more second users are available.

72. The product of claim 70, the method further comprising the steps of:
determining whether the information indicating that the synchronized communication has started is displayable, according to a rule previously set by the users,
wherein the displaying step is performed only when the determining step indicates that the information is displayable.

73. A computer readable medium storing computer instructions for performing a method, the method comprising the steps of:
sending identification information of users to a server terminal;
logging the users on a network, if the server terminal authenticates the users;
obtaining images of the users, using means for photographing;
storing the images of the users in a storage device of the server terminal;
creating a virtual office, using the images of the users and the identification information;
displaying the virtual office to the users; and
providing the users with an experience of the virtual office, using browsers and input devices both previously provided to the respective client terminals.

74. The medium of claim 73, the method further comprising the steps of:
recognizing a first user from the users, when the first user selects one or more second users from the users with the input device of the first user;
displaying information of confirming the selection made by the first user, according to a movement of the input device;
receiving a synchronized communication request from the first user;
notifying the one or more second users of the synchronized communication request being received;
starting synchronized communication between the first user and the one or more second users; and
displaying information indicating that the synchronized communication has started.

75. The medium of claim 74, the method further comprising the step of:
determining whether the one or more second users are available for synchronized communication according to a rule previously set by the users,
wherein the starting step is performed only when the determining step indicates that the one or more second users are available.

76. The medium of claim 74, the method further comprising the step of:
determining whether the information indicating that the synchronized communication has started is displayable, according to a rule previously set by the users,
wherein the displaying step is performed only when the determining step indicates that the information is displayable.

77. An apparatus, comprising:
means for sending identification information of users on a network;
means for authenticating the users, using the identification information;
means for logging on the users to the network;
means for taking images of the users;
means for storing the images of the users;
means for creating a virtual office on the network, using the images of the users and the identification information;
means for displaying the virtual office to the users; and
means for browsing the virtual office.

78. The apparatus of claim 77, further comprising:
recognizing a first user from the users, when the first user selects one or more second users from the users;
displaying information confirming the selection made by the first user;
receiving a synchronized communication request from the first user;
notifying the one or more second users of the synchronized communication request being received;
starting synchronized communication between the first user and the one or more second users; and
displaying information indicating that the synchronized communication has started.

79. The apparatus of claim 78, further comprising:
setting various rules regarding an operation in the virtual office; and
determining whether the one or more second users are available for synchronized communication according to the rules,
wherein the starting means starts the communication only when the determining means indicates that the one or more second users are available.

80. The apparatus of claim 78, further comprising:
setting various rules regarding an operation in the virtual office; and
determining whether the information indicating that the synchronized communication has started is displayable, according to the rules,
wherein the displaying means displays the information only when the determining means indicates that the information is displayable.
